(19) United States
(12) Patent Application Publication
(10) Pub. No.: US 2021/0233398 A1
(43) Pub. Date: Jul. 29, 2021

(54) INFORMATION PROCESSING APPARATUS, INFORMATION PROCESSING METHOD, AND COMPUTER READABLE STORAGE MEDIUM

(71) Applicant: TOYOTA JIDOSHA KABUSHIKI KAISHA, Toyota-shi (JP)

(72) Inventors: Shin SAKURADA, Toyota-shi (JP); Naoki UENOYAMA, Nagoya-shi (JP); Josuke YAMANE, Nisshin-shi (JP); Hikaru GOTOH, Nagoya-shi (JP); Takumi FUKUNAGA, Nisshin-shi (JP); Soutaro KANEKO, Nagoya-shi (JP); Rio MINAGAWA, Nagoya-shi (JP)

(73) Assignee: TOYOTA JIDOSHA KABUSHIKI KAISHA, Toyota-shi (JP)

(21) Appl. No.: 17/152,920

(22) Filed: Jan. 20, 2021

(30) Foreign Application Priority Data
Jan. 23, 2020 (JP) 2020-009411

(51) Int. Cl. G08G 1/0962

(52) U.S. Cl. CPC G08G 1/0962

(57) ABSTRACT

This disclosure achieves smooth traffic. An information processing apparatus has a controller comprising at least one processor configured to perform: obtaining first data representing a driving tendency of a first vehicle; obtaining second data representing a driving tendency of each second vehicle located in the vicinity of the first vehicle; aggregating the second data corresponding to a plurality of the second vehicles thereby to generate reference data; and calculating a degree of similarity between the first data and the reference data thereby to notify a driver of the first vehicle when there is a deviation of a predetermined value or more between the first data and the reference data.

### CROSS REFERENCE TO THE RELATED APPLICATION

This application claims the benefit of Japanese Patent Application No. 2020-009411, filed on Jan. 23, 2020, which is hereby incorporated by reference herein in its entirety.

### BACKGROUND

### Technical Field

The present disclosure relates to a technique for ensuring smooth traffic.

### Description of the Related Art

There are systems for assisting safe driving. For example, Patent Literature 1 discloses an apparatus that collects data related to driving behaviors taken by drivers of vehicles, and visualizes, on a map, what driving behaviors tend to be taken based on the data collected from a plurality of vehicles.

### CITATION LIST

### Patent Literature

Patent Literature 1: Japanese Patent Application Laid-Open No. 2015-203876

### SUMMARY

On a road, a plurality of drivers often take driving behaviors with similar tendencies. However, if some drivers adopt different driving behaviors in such a situation, smooth traffic may be hindered.

The present disclosure has been made in view of the above-mentioned problem, and has for its object to provide a technique for realizing smooth traffic.

### Solution to Problem

An information processing apparatus according to a first aspect of the present disclosure includes a controller comprising at least one processor that is configured to perform: obtaining first data representing a driving tendency of a first vehicle; obtaining second data representing a driving tendency of each second vehicle located in the vicinity of the first vehicle; aggregating the second data corresponding to a plurality of the second vehicles thereby to generate reference data; and calculating a degree of similarity between the first data and the reference data thereby to make a notification to a driver of the first vehicle when there is a deviation of a predetermined value or more between the first data and the reference data.

In addition, an information processing method according to a second aspect of the present disclosure comprises: a step of obtaining first data representing a driving tendency of a first vehicle; a step of obtaining second data representing a driving tendency of each second vehicle located in the vicinity of the first vehicle; a step of aggregating the second data corresponding to a plurality of the second vehicles thereby to generate reference data; and calculating a degree of similarity between the first data and the reference data thereby to make a notification to a driver of the first vehicle when there is a deviation of a predetermined value or more between the first data and the reference data.

Moreover, as a further aspect of the present disclosure, there is provided a program for causing a computer to execute the information processing method that is performed by the information processing apparatus, or a computer readable storage medium in which the program is stored in a non-transitory manner.

### Advantageous Effects of the Invention

According to the present disclosure, it is possible to provide a technique for realizing smooth traffic.

### BRIEF DESCRIPTION OF THE DRAWINGS

FIG. 1 is a system outline view of a first embodiment according to the present disclosure.

FIG. 2 is a system configuration view of a server device and an in-vehicle device according to the first embodiment.

FIG. 3 is a view explaining sensor data obtained by a vehicle that is traveling on a road.

FIG. 4 is a flow chart of the generation processing of driving tendency data carried out by the in-vehicle device.

FIGS. 5A and 5B illustrate examples of databases stored in the server device.

FIG. 6 is a flowchart of driving evaluation processing performed by the server device.

FIG. 7 is a system outline view according to a second embodiment of the present disclosure.

FIG. 8 is a system configuration view of an in-vehicle device according to the second embodiment.

FIG. 9 is a flowchart of the processing performed by the in-vehicle device according to the second embodiment.

### DESCRIPTION OF THE EMBODIMENTS

In recent years, many techniques for safe driving have been proposed in view of the fact that severe punishment for dangerous driving such as a tailgating or road rage action is progressing. For example, there is known a device that monitors an inter-vehicle distance to a preceding vehicle, and determines that a tailgating action has occurred when the inter-vehicle distance becomes a predetermined value or less at a predetermined speed or more.

On the other hand, as a cause of such a tailgating or road rage action, there can be mentioned the presence of a vehicle that is not traveling on the stream. For example, in cases where there is a vehicle traveling at an unreasonably low speed in a passing lane of an expressway, smooth traffic is hindered, which may cause traffic trouble.

An information processing apparatus according to an embodiment includes a controller comprising at least one processor that is configured to perform: obtaining first data representing a driving tendency of a first vehicle; obtaining second data representing a driving tendency of each second vehicle located in the vicinity of the first vehicle; aggregating the second data corresponding to a plurality of the second vehicles thereby to generate reference data; and calculating a degree of similarity between the first data and the reference data thereby to make a notification to a driver of the first vehicle when there is a deviation of a predetermined value or more between the first data and the reference data.

The first data and the second data are data representing driving tendencies of the corresponding vehicles, and can be obtained, for example, based on the results of sensing the corresponding vehicles.

A driving tendency refers to how a vehicle tends to travel, and for example, it may be a tendency related to speed, or a tendency related to position (i.e., a traveling lane, or the like).

By obtaining driving tendencies, for example, it is possible to determine that “vehicle A tends to travel at 80 km/h or more and 100 km/h or less at point X”, and that “vehicle B tends to travel at 100 km/h or more and 110 km/h or less at point X”.

The controller aggregates a plurality of pieces of second data thereby to generate reference data. Thus, it is possible to grasp how a plurality of vehicles located in the vicinity of the first vehicle tend to travel. Then, the controller compares the first data with the reference data, and notifies the driver of the first vehicle when a deviation therebetween is found.

According to such a configuration, it is possible to notify the driver of the first vehicle that there is a possibility that the first vehicle is driving without along the entire stream.

In addition, the first data and the second data may be characterized by data representing driving tendencies of the first vehicle and the second vehicles, respectively, in a predetermined past period of time.

Moreover, the first data may be characterized by data generated by the first vehicle, and the second data may be characterized by data generated by the second vehicles.

The first and second data may be generated based on the results of externally sensing the first and second vehicles, or may be directly transmitted from the first and second vehicles.

Moreover, the controller may be characterized by aggregating the second data generated by each second vehicle in a predetermined range including a point at which the first vehicle generates the first data.

In addition, the controller may be characterized by aggregating the second data generated by each second vehicle in a predetermined period of time including a point in time at which the first vehicle generates the first data.

According to such a configuration, it is possible to detect that the first vehicle traveling at a certain point at a certain point in time is driving, without matching the flow of a plurality of vehicles present in the vicinity thereof.

Further, the driving tendencies may be characterized by tendencies related to speed.

Smooth traffic can be realized by determining whether or not the tendencies related to speed are similar.

Furthermore, the second data may be characterized by further including data representing a preference of a driver of each second vehicle.

The second data may include, for example, data related to a driving lane, a speed range, and the like, which are preferred by each driver.

Still further, the controller may be characterized by aggregating a plurality of pieces of the second data on a lane by lane basis. In addition, the controller may be characterized by calculating the degree of similarity by using the reference data corresponding to a lane in which the first vehicle is traveling.

With this, it becomes possible to make an appropriate determination in an environment in which a traveling speed range differs for each lane, such as an expressway.

In addition, the controller may be characterized by performing weighting according to a distance between the first vehicle and each second vehicle at the time of aggregating a plurality of pieces of the second data.

According to such a configuration, it is possible to give a larger weight to a vehicle closer to the first vehicle, i.e., a vehicle more greatly affected by the driving behavior of the first vehicle, thus making it possible to perform more appropriate determination.

Moreover, the controller may be characterized by determining a content of the notification based on a magnitude of the deviation.

This is because the larger the deviation between the driving tendencies is, the more stress may be applied to the drivers of nearby vehicles.

Hereinafter, embodiments of the present disclosure will be described with reference to the drawings. The configurations of the following embodiments are merely some examples, and the present disclosure is not limited to the specific configurations of the embodiments.

### First Embodiment

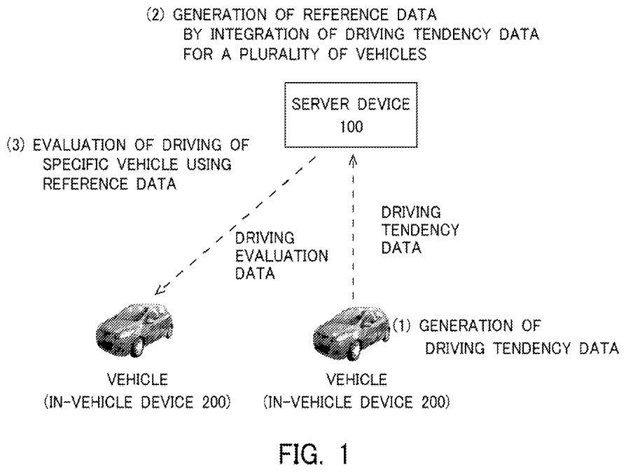

An outline of a vehicle system according to a first embodiment will be described with reference to FIG. 1. The vehicle system according to the present embodiment includes a server device 100 that evaluates driving of vehicles, and a plurality of in-vehicle devices 200 mounted on a plurality of vehicles, respectively.

The server device 100 is a device that performs radio or wireless communication with the plurality of in-vehicle devices 200 under management thereof, and generates data for evaluating driving of a specific vehicle (hereinafter, driving evaluation data) based on the data transmitted and received. Specifically, data (hereinafter, driving tendency data) representing the driving tendencies of a plurality of vehicles are received from the plurality of vehicles that are traveling. In addition, by using the plurality of pieces of received driving tendency data, it is determined to what extent the driving tendency of the specific vehicle deviates from the driving tendencies of the plurality of other vehicles. Thus, for example, it is possible to give advice to a vehicle that is not traveling in a traffic stream.

The in-vehicle devices 200 are each a computer mounted on a vehicle. The in-vehicle devices 200 each have a function of generating driving tendency data and transmitting it to the server device 100, and also a function of providing advice to the driver based on the driving evaluation data received from the server device 100.

Note that each in-vehicle device 200 only needs to move together with a vehicle, and does not need to be a device fixed to a vehicle. For example, it may be a portable terminal or the like carried by an occupant.

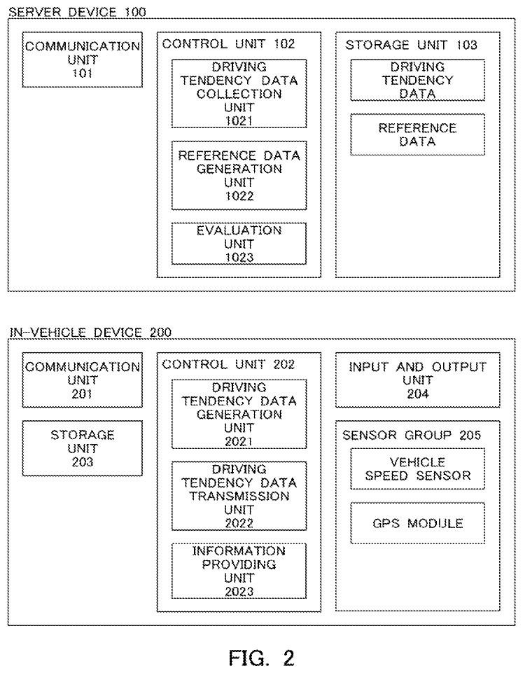

Next, components of the system will be described with reference to FIG. 2.

The server device 100 can be composed of a general-purpose computer. That is, the server device 100 can be configured as a computer including a processor such as a CPU, a GPU or the like, a main storage device such as a RAM, a ROM or the like, and an auxiliary storage device such as an EPROM, a hard disk drive, a removable medium or the like. Here, note that the removable medium may be, for example, a USB memory or a disk recording medium such as a CD or a DVD. An operating system (OS), various kinds of programs, various kinds of tables, and the like are stored in the auxiliary storage device, and the programs stored in the auxiliary storage device are loaded into a work area of the main storage device and executed there, so that individual component parts or the like are controlled through the execution of the programs, thereby making it possible to achieve each function meeting a predetermined purpose, as described below. However, some or all of the functions may be implemented by a hardware circuit, such as an ASIC or an FPGA.

The device 100 includes a communication unit 101, a control unit 102, and a storage unit 103.

The communication unit 101 is a communication interface for radio or wireless communication with the in-vehicle devices 200. A communication method used by the communication unit 101 may be any method, such as Wi-Fi (registered trademark), dedicated short range communications (DSRC), millimeter-wave communications or the like. Further, the communication unit 101 may be one that communicates with the in-vehicle devices 200 via a wide area network such as the Internet, or the like.

The control unit 102 is an arithmetic operation device that controls the server device 100. The control unit 102 can be realized by an arithmetic processing unit such as a CPU or the like.

The control unit 102 is configured to include three functional modules, i.e., a driving tendency data collection unit 1021, a reference data generation unit 1022, and an evaluation unit 1023. Each functional module may be realized by executing a stored program by means of the CPU.

Here, note that in the following description, a vehicle that receives advice based on driving evaluation data is referred to as an evaluation target vehicle (first vehicle), and a vehicle that provides driving tendency data is referred to as a data providing vehicle (second vehicle).

The driving tendency data collection unit 1021 collects, from the in-vehicle devices 200 mounted on the vehicles under management, data (driving tendency data) representing the tendencies of driving of the vehicles. A method of generating the driving tendency data by the in-vehicle devices 200 will be described later.

The reference data generation unit 1022 integrates the driving tendency data transmitted from the plurality of vehicles thereby to generate reference data. By integrating the driving tendency data transmitted from the vehicles present in the vicinity of the evaluation target vehicle, data for evaluating the driving of the evaluation target vehicle can be generated.

The evaluation unit 1023 evaluates the driving of the evaluation target vehicle based on the driving tendency data generated by the evaluation target vehicle and the reference data generated by the reference data generation unit 1022. Specifically, the driving tendency data corresponding to the evaluation target vehicle is compared with the reference data, so that a degree of similarity therebetween is obtained. Here, in cases where a deviation between the driving tendency data and the reference data is large, it means that the driving tendency of the evaluation target vehicle deviates from the driving tendencies of other vehicles traveling in the vicinity thereof. In this case, the evaluation unit 1023 transmits the driving evaluation data including that information to the in-vehicle device 200 mounted on the evaluation target vehicle. Thus, the driver of the evaluation target vehicle can recognize that the flow of traffic is disturbed.

The storage unit 103 is configured to include a main storage device and an auxiliary storage device. The main storage device is a memory in which control programs or the like executed by the control unit 102 and data used by the control programs are developed. The auxiliary storage device is a device that stores control programs or the like executed by the control unit 102 and data used by the control programs.

In addition, the storage unit 103 stores the driving tendency data collected by the driving tendency data collection unit 1021 and the reference data generated by the reference data generating unit 1022.

The in-vehicle device 200 is configured to include a communication unit 201, a control unit 202, a storage unit 203, an input and output unit 204, and a sensor group 205.

The communication unit 201 is a communication interface for radio or wireless communication with the server device 100. A communication method used by the communication unit 201 may be any method, such as Wi-Fi (registered trademark), dedicated short range communications (DSRC), cellular communications, or the like.

The control unit 202 is an arithmetic operation device that controls the in-vehicle device 200. The control unit 202 can be realized by an arithmetic processing unit such as a CPU or the like.

The control unit 202 is configured to include three functional modules, i.e., a driving tendency data generation unit 2021, a driving tendency data transmission unit 2022, and an information providing unit 2023. Each functional module may be realized by executing a stored program by means of the CPU.

The driving tendency data generation unit 2021 generates driving tendency data representing the driving tendency of the own vehicle based on the sensor data obtained from the sensor group 205. The sensor data is, for example, data representing at least one of position information, a vehicle speed, a steering angle, a yaw rate, and the like. In the present embodiment, the vehicle speed is used as the sensor data.

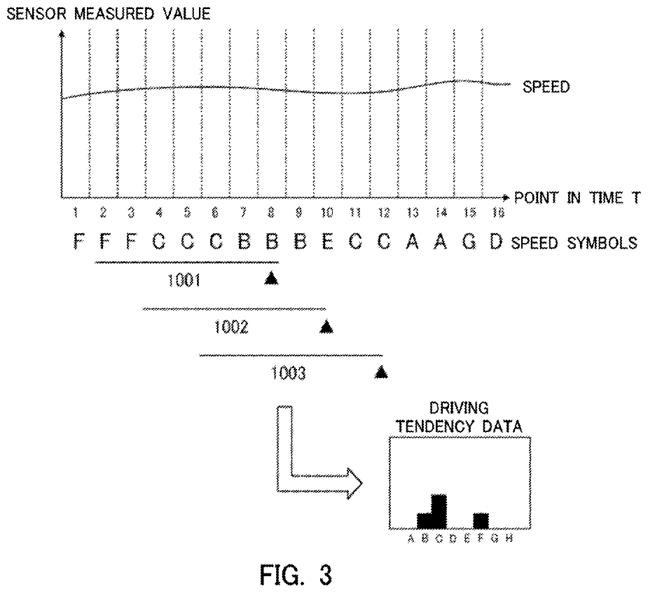

A specific method of generating the driving tendency data will be described later with reference to FIG. 3.

The driving tendency data transmission unit 2022 transmits the driving tendency data generated by the driving tendency data generation unit 2021 to the server device 100.

The information providing unit 2023 outputs advice regarding driving based on the driving evaluation data received from the server device 100. For example, because the vehicle speed is low, advice indicating that the vehicle should be accelerated in order to get on the flow is outputted via the input and output unit 204 to be described later.

The storage unit 203 is configured to include a main storage device and an auxiliary storage device. The main storage device is a memory in which control programs or the like executed by the control unit 202 and data used by the control programs are developed. The auxiliary storage device is a device that stores control programs or the like executed by the control unit 202 and data used by the control programs.

The input and output unit 204 is an interface for inputting and outputting information. The input and output unit 204 is configured to include, for example, a display device or a touch panel. The input and output unit 204 may include a keyboard, a speaker, a touch screen, and the like.

The sensor group 205 is configured to include a means for obtaining speed and position information of the own vehicle. The sensor group 205 includes, for example, a vehicle speed sensor, a GPS module and the like. The sensor data obtained by the sensors included in the sensor group 205 is transmitted to the control unit 202 (the driving tendency data generation unit 2021) as needed. Here, note that the sensor group 205 does not necessarily need to be built in the in-vehicle device 200. For example, the sensor group 205 may be a component(s) of a vehicle in which the in-vehicle device 200 is mounted.

Next, specific processing performed by the server device 100 and the in-vehicle device 200 will be described.

First, processing will be described in which the in-vehicle device 200 (the driving tendency data generation unit 2021) generates the driving tendency data of the own vehicle based on the sensor data. FIG. 3 is a view illustrating the sensor data obtained by a vehicle traveling on a road. In the present embodiment, the vehicle speed is exemplified as the sensor data.

The sensor data is generated at every predetermined time step. In FIG. 3, 16 time steps are shown.

The driving tendency data generation unit 2021 accumulates sensor data and generates driving tendency data by using the sensor data in the latest predetermined period of time for each predetermined cycle.

In the example of FIG. 3, for example, at time t=8, the driving tendency data generation unit 2021 generates driving tendency data by using the sensor data in a period of time indicated by a symbol 1001.

In addition, at time t=10, the driving tendency data generation unit 2021 generates driving tendency data using the sensor data in a period of time indicated by a symbol 1002.

Similarly, at time t=12, the driving tendency data generation unit 2021 generates driving tendency data by using the sensor data in a period of time indicated by a symbol 1003.

In this example, the vehicle speeds are classified into groups A to H (speed symbols) by a predetermined method, and a histogram representing the number of speed symbols in a predetermined period of time is generated. This histogram is the driving tendency data in the present embodiment. In other words, the driving tendency data is data representing the tendency of the speed in a certain period of time (in this example, for seven time steps).

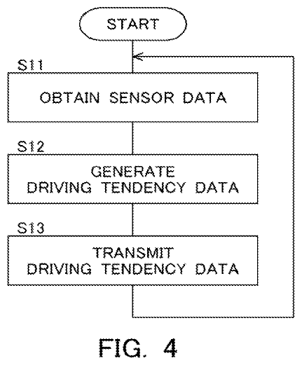

FIG. 4 is a flowchart of driving tendency data generation processing performed by the in-vehicle device 200. This processing is periodically performed while the vehicle is traveling.

First, in step S11, the driving tendency data generation unit 2021 obtains sensor data from the sensor group 205. As described above, the sensor data includes the vehicle speed of the data providing vehicle.

Then, in step S12, the driving tendency data generation unit 2021 generates driving tendency data according to the above-described method. The driving tendency data thus generated is stored in association with an identifier, position information and a time stamp of the vehicle.

Subsequently, in step S13, the driving tendency data transmission unit 2022 transmits the generated driving tendency data to the server device 100.

By periodically executing the above-described processing by means of a plurality of in-vehicle devices 200, the server device 100 can collect driving tendency data from the plurality of in-vehicle devices 200.

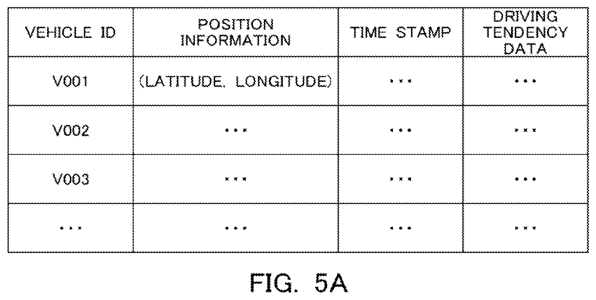

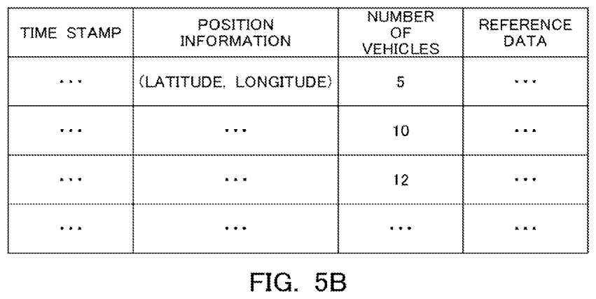

FIG. 5A is an example of a database storing driving tendency data, which is stored in the server device 100.

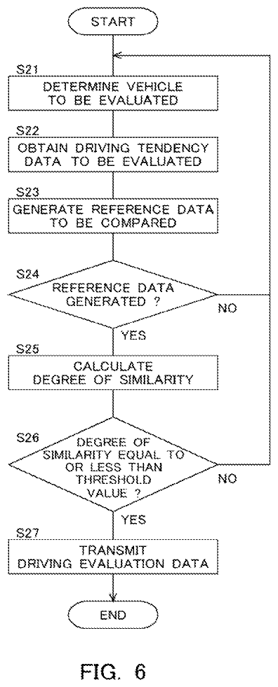

Next, processing in which the server device 100 evaluates the driving of the evaluation target vehicle will be described with reference to FIG. 6. The processing illustrated in FIG. 6 is performed at a predetermined cycle.

First, in step S21, the evaluation unit 1023 determines an evaluation target vehicle which is to be evaluated.

The server device 100 may determine an evaluation target vehicle based on a request transmitted from an in-vehicle device 200. In this case, a vehicle, which has transmitted the request within the predetermined cycle, is set as an evaluation target vehicle. In cases where there are a plurality of evaluation target vehicles, the server device 100 performs the processing described below in a repeated manner.

In step S22, the evaluation unit 1023 obtains the latest driving tendency data transmitted by an evaluation target vehicle.

Thereafter, in step S23, the reference data generating unit 1022 generates reference data to be compared. The reference data is generated by integrating the driving tendency data transmitted by the vehicles traveling in the vicinity of the evaluation target vehicle.

In this step, the position and the time stamp of the evaluation target vehicle are specified with reference to the driving tendency data generated by the evaluation target vehicle. In addition, pieces of driving tendency data generated within a predetermined range around the position and within a predetermined time from the time stamp are extracted. The predetermined range may be defined by a distance or a road segment.

Then, the driving tendency data thus extracted are integrated to generate reference data.

For example, in cases where each piece of the driving tendency data is a histogram, the processing of taking an arithmetic mean or average of a plurality of histograms is performed. This makes it possible to average the driving tendencies of vehicles that are geographically and temporally close to the evaluation target vehicle. Here, note that if data representing a plurality of driving tendencies can be obtained, a value other than the arithmetic mean may be used. The generated reference data is attached with a time stamp, and is stored in the storage unit 103. FIG. 5B is an example of a database that stores reference data.

In cases where reference data has been able to be generated by the driving tendency data satisfying a certain condition (Yes in step S24), the processing shifts to step S25. On the other hand, when there is no driving tendency data satisfying the condition and no reference data has been able to be generated (No in step S24), the processing returns to step S21.

In step S25, the evaluation unit 1023 calculates a degree of similarity between the driving tendency data generated by the evaluation target vehicle and the reference data. The degree of similarity may be obtained by any method as long as multi-dimensional data can be compared with each other. In the present embodiment, the more similar is the tendency related to speed between the evaluation target vehicle and the data providing vehicle, a higher degree of similarity is calculated.

Here, it is understood that in cases where the degree of similarity calculated is lower than a predetermined value (Yes in step S26), the evaluation target vehicle traveling at a certain point are driving in a state out of the driving tendencies of other vehicles traveling in the vicinity of that point. When the degree of similarity obtained is less than a threshold value, the processing shifts to step S27, and the driving evaluation data is transmitted to the in-vehicle device 200 mounted on the evaluation target vehicle.

The driving evaluation data is data representing that the driving tendency of the own vehicle deviates from those of other vehicles. The driving evaluation data may include the degree of similarity calculated. The in-vehicle device 200 (the information providing unit 2023) generates advice for the driver based on the driving evaluation data, and outputs the advice via the input and output unit 204. For example, in cases where the degree of similarity calculated is low, advice to the effect that the cruising speed of the own vehicle is different from those of the other vehicles is given.

As described above, according to the first embodiment, it is possible to calculate driving tendencies of a plurality of vehicles based on the speeds of the vehicles, thus making it possible to provide information to vehicles having different driving tendencies. According to such a configuration, it is possible to provide the driver of the target vehicle with advice to the effect that there is a possibility that the flow of traffic is disturbed, thereby making it possible to ensure smooth traffic.

### Modification of the First Embodiment

In the first embodiment, a tendency related to speed is utilized as a driving tendency, but driving tendency data may be generated by making use of other sensor data.

For example, the sensor group 205 may include a means (sensor) for sensing the driving behaviors or traveling conditions of other vehicles. Such sensors include, for example, sensors that obtain a steering angle, an acceleration, a state of blinkers, an inter-vehicle distance, and the like.

In addition, the driving tendency data collection unit 1021 may generate the driving tendency data based on the sensor data. For example, feature value vectors composed of a plurality of pieces of sensor data may be clustered, and a histogram representing the results obtained may be used as driving tendency data.

According to such a configuration, it is possible to determine a driving tendency based on factors other than the vehicle speed. For example, in cases where there is a vehicle that is driving with a smaller inter-vehicle distance than other vehicles, this can be detected.

### Second Embodiment

In the first embodiment, the server device 100 generates driving evaluation data by using the driving tendency data collected from the in-vehicle devices 200 mounted on the data providing vehicles, and transmits the driving evaluation data to the in-vehicle device 200 mounted on the evaluation target vehicle.

In contrast to this, in a second embodiment, the in-vehicle device 200 mounted on each data providing vehicle transmits the driving tendency data of the own vehicle, and the in-vehicle device 200 mounted on a vehicle (evaluation target vehicle), which receives the driving tendency data, generates driving evaluation data. That is, this second embodiment is an embodiment in which the whole processing is completed only by means of the in-vehicle devices 200 without involving the server device 100.

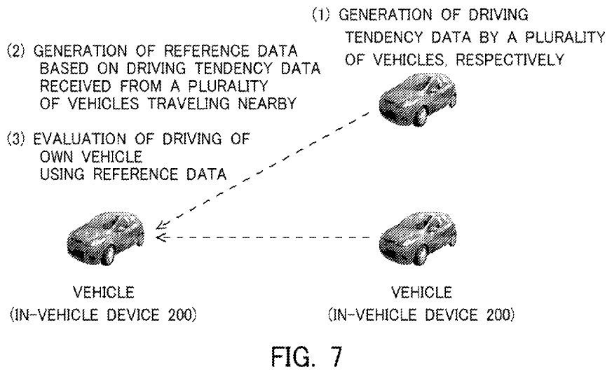

FIG. 7 is a system outline view of the second embodiment. In the second embodiment, a plurality of in-vehicle devices 200 communicate with one another thereby to realize the functions described in the first embodiment.

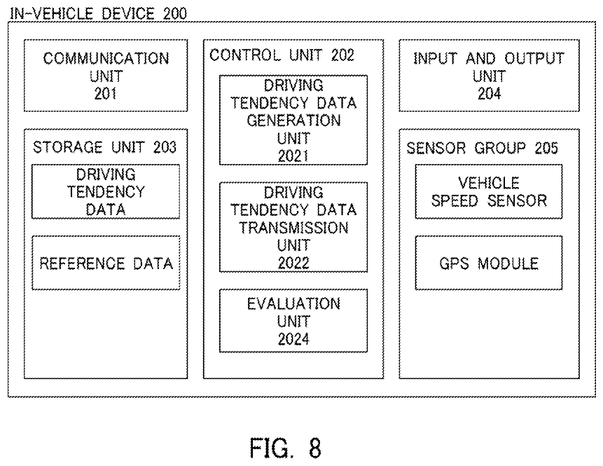

FIG. 8 is a system configuration view of an in-vehicle device 200 according to the second embodiment.

The communication unit 201 in the second embodiment is a communication interface for performing radio or wireless vehicle-to-vehicle communication.

In the second embodiment, the control unit 202 is configured to include an evaluation unit 2024, instead of the information providing unit 2023.

In addition, in the second embodiment, the storage unit 203 stores the driving tendency data of the own vehicle and the other vehicles, as well as the reference data generated by the own device.

The processing performed by the in-vehicle device 200 in the second embodiment will be described.

Similar to the first embodiment, the driving tendency data generation unit 2021 in this second embodiment generates driving tendency data representing the driving tendency of the own vehicle based on the sensor data obtained from the sensor group 205 of the own vehicle. As a method of generating the driving tendency data, the same method as that in the first embodiment can be used.

The driving tendency data thus generated is temporarily stored in the storage unit 203.

The driving tendency data transmission unit 2022 broadcasts the driving tendency data generated by the driving tendency data generation unit 2021 by vehicle-to-vehicle communication. The driving tendency data transmission unit 2022 broadcasts the latest one of the driving tendency data generated by the own vehicle.

The evaluation unit 2024 evaluates the driving of the own vehicle based on the driving tendency data transmitted from the other vehicles.

Specifically, first, the driving tendency data broadcast by the in-vehicle devices 200 mounted on other vehicles are sequentially received. This makes it possible to obtain the driving tendency data generated by the vehicles existing in the vicinity of the own vehicle.

Second, reference data is generated by integrating the driving tendency data received from a plurality of vehicles (in-vehicle devices 200) within the latest predetermined period of time. The reference data is obtained by integrating the driving tendencies of the plurality of vehicles traveling in the vicinity of the own vehicle. As a method of generating the reference data, the same method as that in the first embodiment can be used.

Third, the generated reference data and the latest driving tendency data generated by the own vehicle are compared with each other to obtain a degree of similarity therebetween. Here, in cases where a deviation between the driving tendency data and the reference data is large, it means that the driving tendency of the own vehicle deviates from the driving tendency of other vehicles traveling in the vicinity of the own vehicle. In this case, the evaluation unit 2024 generates advice for the driver based on the degree of similarity calculated, and outputs the advice via the input and output unit 204.

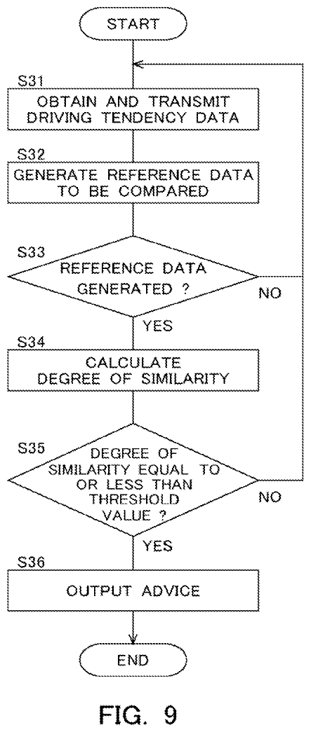

FIG. 9 is a flowchart of the processing executed by the in-vehicle device 200 according to the second embodiment. The illustrated processing is executed at a predetermined cycle when the own vehicle is traveling.

Here, note that, separately from the processing of FIG. 9, the evaluation unit 2024 receives the driving tendency data broadcast by the in-vehicle devices 200 mounted on other vehicles as needed, and stores the driving tendency data thus received in the storage unit 203.

First, in step S31, the driving tendency data generation unit 2021 obtains sensor data from the sensor group 205, and generates driving tendency data based on the sensor data, by using the method described above. When the driving tendency data is generated, the driving tendency data transmission unit 2022 broadcasts the driving tendency data thus generated, and at the same time stores the driving tendency data in the storage unit 203.

In step S32, the evaluation unit 2024 generates reference data in the same manner as in the first embodiment, by using the driving tendency data received in the latest predetermined period of time.

In steps S33 through S34, the degree of similarity between the driving tendency data of the own vehicle and the reference data is calculated in the same manner as in steps S24 to S25.

As a result, in cases where the degree of similarity thus obtained is lower than a threshold value (Yes in step S35), the processing shifts to step S36, and the evaluation unit 2024 outputs advice for the driver via the input and output unit 204.

### Modification of the Second Embodiment

In the second embodiment, the in-vehicle device 200 generates the driving tendency data based on the sensor data, but the driving tendency data may be accompanied by information that is not directly related to the driving tendency. For example, data representing the driver's preference for driving may be transmitted while being attached to the driving tendency data.

In this case, the in-vehicle device 200, which has received the driving tendency data, may generate reference data by reflecting the driver's preference. For example, in cases where a driver, who prefers to keep a long inter-vehicle distance, is driving a data providing vehicle, the in-vehicle device 200 mounted on the data providing vehicle may broadcast the driving tendency data with preference data representing a desire for a longer inter-vehicle distance attached thereto. In addition, the in-vehicle device 200, which has received this data, may generate reference data that reflects a longer inter-vehicle distance.

In addition, when the reference data is generated, weighting may be performed based on a relative distance between the vehicles, instead of taking a simple average. For example, the reference data may be generated by giving a larger weight to the driving tendency data transmitted from a vehicle closer to the evaluation target vehicle. According to such a configuration, a larger weight can be given to a vehicle that is more likely to be affected by the driving behavior of the evaluation target vehicle.

Moreover, road lanes may be taken into account when generating the reference data. For example, the reference data may be generated on a lane by lane basis by attaching information related to a traveling lane to the driving tendency data. In addition, the reference data may be generated by using only the driving tendency data generated in the same lane as that of the evaluation target vehicle. Further, the reference data may be generated by giving a larger weight to a lane as the lane is closer to the evaluation target vehicle.

According to such a configuration, an appropriate determination can be made in a road environment (e.g., an expressway) in which the cruising speed may vary depending on the lane of travel.

### Modifications

The above-mentioned embodiments and modification are only some examples, and the present disclosure can be implemented while being changed or modified suitably within a range not departing from the spirit and scope thereof.

For example, the processing, units, devices, measures or the like described in the present disclosure can be freely combined and implemented as long as no technical contradiction occurs.

In addition, in the description of the embodiments, advice related to driving is outputted, but the content of the advice may be changed according to the magnitude of the degree of similarity calculated. For example, advice may be generated in which the lower the degree of similarity, the more is emphasized the fact that the deviation between the driving tendencies is large.

Moreover, the processing(s) explained as carried out by a single device may be carried out by a plurality of devices. Alternatively, the processing(s) explained as carried out by different devices may be carried out by a single device. In a computer system, whether each function thereof is achieved by what kind of hardware configuration (server configuration) can be changed in a flexible manner.

The present disclosure can also be achieved by supplying a computer program to a computer that implements the functions explained in the above-mentioned embodiments and modifications, and by reading out and executing the program by means of one or more processors of the computer. Such a computer program may be supplied to the computer by a non-transitory computer readable storage medium that can be connected with a system bus of the computer, or may be supplied to the computer through a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, any type of medium suitable for storing electronic commands.

What is claimed is:

1. An information processing apparatus having a controller comprising at least one processor configured to perform:
obtaining first data representing a driving tendency of a first vehicle;
obtaining second data representing a driving tendency of each second vehicle located in the vicinity of the first vehicle;
aggregating the second data corresponding to a plurality of the second vehicles thereby to generate reference data; and
calculating a degree of similarity between the first data and the reference data thereby to make a notification to a driver of the first vehicle when there is a deviation of a predetermined value or more between the first data and the reference data.

2. The information processing apparatus according to claim 1, wherein
the first data and the second data are data representing driving tendencies of the first vehicle and the second vehicles, respectively, in a past predetermined period of time.

3. The information processing apparatus according to claim 1, wherein
the first data is data generated by the first vehicle, and
the second data is data generated by the second vehicles.

4. The information processing apparatus according to claim 3, wherein
the controller aggregates the second data generated by the second vehicles in a predetermined range including a point at which the first vehicle generates the first data.

5. The information processing apparatus according to claim 4, wherein
the controller aggregates the second data generated by the second vehicles in a predetermined period of time including a point in time at which the first vehicle generates the first data.

6. The information processing apparatus according to claim 1, wherein
the driving tendencies are tendencies related to speed.

7. The information processing apparatus according to claim 1, wherein
the second data further includes data representing a preference of a driver of each second vehicle.

8. The information processing apparatus according to claim 1, wherein
the controller aggregates a plurality of pieces of the second data on a lane by lane basis.

9. The information processing apparatus according to claim 8, wherein
the controller calculates the degree of similarity by using the reference data corresponding to a lane in which the first vehicle is traveling.

10. The information processing apparatus according to claim 1, wherein
the controller performs weighting according to a distance between the first vehicle and each second vehicle when aggregating a plurality of pieces of the second data.

11. The information processing apparatus according to claim 1, wherein
the controller determines a content of the notification based on a magnitude of the deviation.

12. An information processing method comprising:
a step of obtaining first data representing a driving tendency of a first vehicle;
a step of obtaining second data representing a driving tendency of each second vehicle located in the vicinity of the first vehicle;
aggregating the second data corresponding to a plurality of the second vehicles thereby to generate reference data; and
a step of calculating a degree of similarity between the first data and the reference data thereby to make a notification to a driver of the first vehicle when there is a deviation of a predetermined value or more between the first data and the reference data.

13. The information processing method according to claim 12, wherein
the first data and the second data are data representing driving tendencies of the first vehicle and the second vehicles, respectively, in a past predetermined period of time.

14. The information processing method according to claim 12, wherein
the first data is data generated by the first vehicle, and
the second data is data generated by the second vehicles.

15. The information processing method according to claim 14, wherein
the second data generated by the second vehicles is aggregated in a predetermined range including a point at which the first vehicle generates the first data.

16. The information processing method according to claim 15, wherein
the second data generated by the second vehicles is aggregated in a predetermined period of time including a point in time at which the first vehicle generated the first data.

17. The information processing method according to claim 12, wherein
the driving tendencies are tendencies related to speed.

18. The information processing method according to claim 12, wherein
the second data further includes data representing a preference of a driver of each second vehicle.

19. The information processing method according to claim 12, wherein
a plurality of pieces of the second data are aggregated on a lane by lane basis.

20. The information processing method according to claim 19, wherein
the degree of similarity is calculated by using the reference data corresponding to a lane in which the first vehicle is traveling.

21. A non-transitory computer readable storage medium with a program stored therein for causing a computer to execute the information processing method according to claim 12.
